(19) United States
(12) Patent Application Publication
(10) Pub. No.: US 2008/0256596 A1
(43) Pub. Date: Oct. 16, 2008

(54) SYSTEM AND METHOD FOR MARKETING IN A DEVICE DEPENDENT RIGHTS PROTECTION FRAMEWORK

(76) Inventor: Seiji Eto, Mountain View, CA (US)

Correspondence Address: LAW OFFICE OF DUANE S. KOBAYASHI, P.O. Box 4160, Leesburg, VA, 20177, US

(21) Appl. No.: 11/734,249

(22) Filed: Apr. 11, 2007

(51) Int. Cl. G06F 7/04

(52) U.S. Cl. 726/2

(57) ABSTRACT

A system and method for marketing in a device dependent rights protection framework where digital property is protected through the binding of at least one unique client device identifier with the digital property in the creation of a protected content file. Decryption at a client device would be based on a comparison of the unique client device identifier that is extracted from the protected content file with a unique client device identifier of the device that is seeking to access the digital property. If such a comparison indicates that access is unauthorized, marketing information is provided based on information extracted from the protected content file.

### BACKGROUND

1. Field of the Invention

The present invention relates generally to marketing and promotions, and more particularly, to a system and method for marketing in a device dependent rights protection framework.

2. Introduction

In recent years there has been an exponential growth of the Internet, coupled with advances in technology resulting in software programs, music, books, video games, even full-length movies, becoming available in high-quality, easily reproducible and easily transmitted digital formats. This has resulted in both unparalleled marketing opportunities and major challenges for manufacturers and distributors of these digital properties. The same factors that make these digital properties attractive to market, purchase and distribute also make them easy prey for pirates to steal and either sell or give away, resulting in huge losses in revenue for developers and distributors of these digital properties.

This dilemma has resulted in a series of defensive maneuvers to thwart the pirates. These efforts have produced various content protection schemes that control the unauthorized distribution of digital content. Notwithstanding the effectiveness of these content protection schemes, there is still a need for developers and distributors of digital content to be able to market and distribute their products over the Internet and other networks. What is needed therefore is a mechanism that enables these developers and distributors to market the digital content even when unauthorized distribution occurs. This would enable the developers and distributors to capitalize on all available distribution channels.

### SUMMARY

A system and/or method for marketing in a device dependent rights protection framework, substantially as shown in and/or described in connection with at least one of the figures, as set forth more completely in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 Illustrates a computer network environment that includes a client who desires content, a content provider and a network through which they can communicate.

FIG. 2 is a flow chart of a process used to create a protected content file.

FIG. 3 is a flow chart of a process used to grant or deny access by a client to a protected content file.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Addressing the critical need of safely transmitting valuable intellectual property over networks, including the Internet, should also consider the ease of granting access to the digital property by authorized purchasers who often possess a plurality of playback devices. A client seeking to play desired content on a plurality of devices can be granted authorization to do so, while also preventing unauthorized access by anyone not in possession of one of the specific set of client devices.

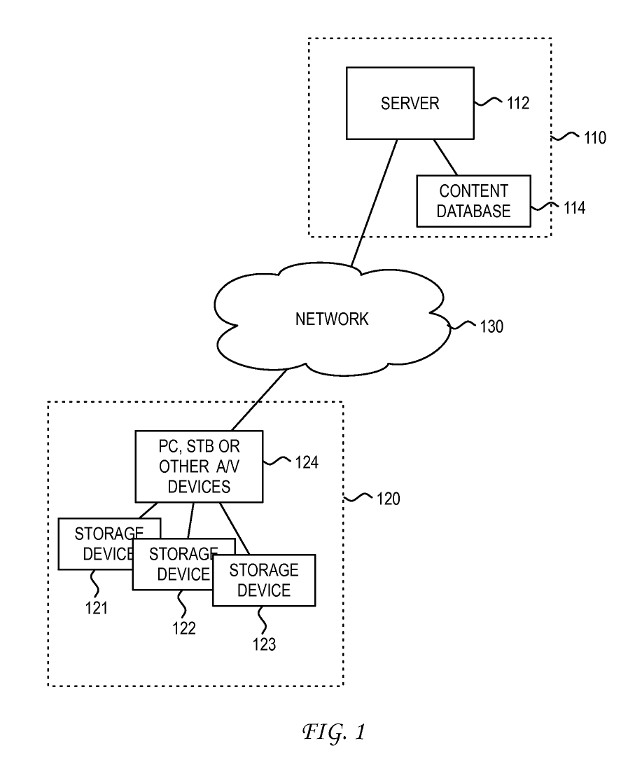

FIG. 1 illustrates a computer network environment that includes client 120 communicating with content provider 110 through network 130. In various embodiments, the network can include a wide area network (WAN) such as the Internet, a local area network (LAN) or a combination of the two. Client 120 is generally operative to communicate with content provider 110 to identify and obtain digital properties.

As illustrated, content provider 110 includes server 112 that receives and transmits data with clients 120, and a storage device 114 that contains a database used to store content available to be purchased and downloaded by clients 120. Client 120 can include at least one client parent device 124, and a plurality of client child devices 121, 122, 123. In one embodiment, client parent device 124 represents a processing device such as a personal computer (PC), set top box (STB), or other audio/video device (e.g., mobile phone, personal digital assistant, etc.) that can communicate with server 112, while client child devices can represent a storage device or other device that can receive data that is retrieved by client parent device 124. Each device 121, 122, 123, 124 can include one or more unique device identifiers that can be retrieved electronically and which precisely identify the device.

As noted, the client 120 can include one or more of a class of devices such as a PC, STB, other audio/video devices (or any network-ready device), a storage device, a portable music/video player, a personal digital assistant, a portable phone, or any of a number of devices capable of accessing electronic files. Furthermore, a plurality of client storage devices 121, 122, 123 that are usable by client parent device 124 may include a hard disk drive, a removable disk (such as a compact disk (CD)), digital versatile disk (DVD), floppy disk, ZIP disk, flash cards) or other media, each of which also possesses one or more unique identifiers that are retrievable by electronic means and which are ideally non-erasable and non-changeable. In one example, a unique identifier associated with each one of a plurality of storage devices comprises one or more of the following: product ID number, serial number or product revision number.

In one embodiment, server 112 is a Sun J2EE Web Server. However, any server that can operate in a web environment could be used. Since the content transmitted to client 120 is to be protected, all content transmitted over the network 130 can be encrypted. In one embodiment, encryption is performed before the content is stored in content database 114, thereby reducing the processing time during client transactions. In an alternative embodiment, encryption of the content is performed during a transaction when the content is being requested by client 120.

In the environment of FIG. 1, protected content can be transmitted to a client for use by a plurality of client devices. In this process, a plurality of unique client device identifiers are bound to the digital content. This is desirable since most clients seeking content possess multiple devices suitable for playback of digital content. In one embodiment, a device identifier table is used to store the unique device identifiers associated with a respective plurality of client devices 121, 122, 123, 124.

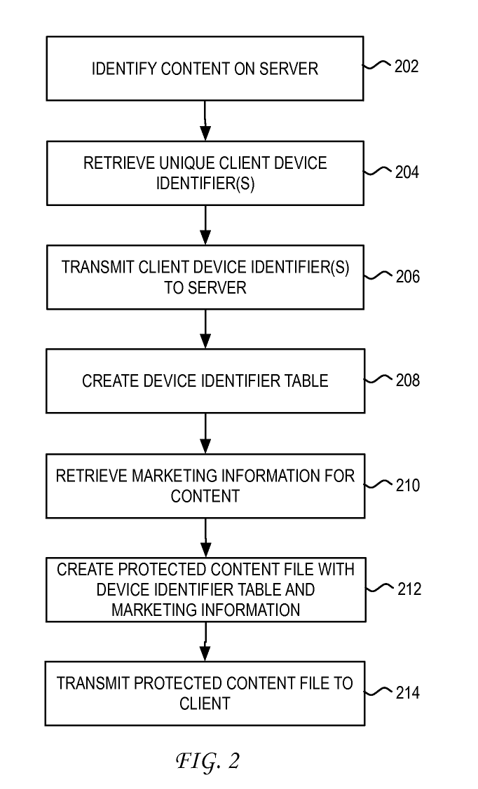

FIG. 2 is a flowchart showing a process in which a client identifies and requests desired content, and then receives it in encrypted form. The process begins at step 202 where client 120 identifies desired content located in content database 114 at server 112 of a content provider 110. At step 204, one or more unique client device identifiers associated with a respective plurality of devices 121, 122, 123, 124 are retrieved. In one example, the unique identifier for a PC hard disk drive could include the product ID number and the serial number for the hard drive (or possibly even the PC itself). In another example, the unique identifier for a portable music player could include the serial number of the player and a product revision number.

Next, at step 206, the retrieved unique client device identifiers are encrypted and transmitted over the network 130 from client 120 to server 112 of content provider 110. These client device identifiers are used to create a device identifier table at step 208. In general, the client device identifiers give content provider 110 information by which it can accurately identify a plurality of devices and/or storage media, which client 120 would utilize in seeking access to the desired content.

At step 210, marketing information is retrieved. In one embodiment, the marketing information is related to the content. In another embodiment, the marketing information can also be based in part on the identity, demographic, preferences, etc. of the individual purchasing rights in the content. In one example, the marketing information includes one or more uniform resource locators (URLs). These URLs can represent various web addresses that are related to the identified content. In general, the information presented at those web addresses can relate to purchasing, coupons, promotions, artists, actors, or other information relating to the identified content. In another example, information such as that presented at the web addresses can be included in the marketing information directly. In yet another example, information such as a printable file can be used to provide a promotional coupon to the user. As will be described in greater detail below, it is a feature of the present invention that the marketing information (e.g., content-related URLs) can be included with the protected content file for distribution with the protected content. In this manner, the marketing information can be used as part of a marketing campaign that can be invoked based on a user's interaction with the protected content file.

Indeed, it is a further feature of the present invention that the marketing information can be invoked whether or not the user is authorized to access the protected content. As will be described in greater detail below, the identification of the access request as authorized or unauthorized can be used to determine which marketing information should be invoked. For example, unauthorized access requests can be met by directing a web browser to a URL address that enables the user to purchase access rights to the protected content file. In another example, authorized access requests can be met by directing a web browser to a URL address that enables the user to purchase additional content related to the author, artist, actor, etc. associated with the protected content. As would be appreciated, various marketing or promotional campaigns can be implemented depending on the nature of the content and the state of access of such content.

After the appropriate marketing information has been retrieved, the protected content file is created at step 212. In this process, the desired content is bound to the device identifier table. This binding ensures that access to the desired content is restricted to only those devices represented in the device identifier table.

In one embodiment, the desired content can also be bound to a timestamp (in addition to or in place of the device identifier table) that is used to limit the time duration during which the content can be accessed by client device(s). For example, a timestamp can be bound to the content that specifies that a particular movie file can be viewed for a three or five day time period in a similar manner to a conventional movie rental. In this embodiment, access to the content can be conditioned on a comparison of a current time to the timestamp. In one embodiment, the current time is retrieved from a network source to thereby prevent tampering with the time readings at a local device.

In addition to the inclusion of the content and the device identifier table, the protected content file creation process also includes the retrieved marketing information (e.g., URL(s)). As the retrieved marketing information may not represent intellectual property in and of themselves, the marketing information need not be protected. Accordingly, the marketing information can be included in an unencrypted portion of the protected content file. In this configuration, the marketing information can be accessed even if the user does not gain access to the protected content. In an alternative embodiment, the marketing information can also be protected to ensure that the marketing information is not modified by a third party during distribution. This would ensure, for example, that marketing information such as a URL directs the user to a valid web page, and not to a web page that is designed for malicious intent.

The protected content file created in step 212, which includes encrypted content combined with the device identifier table, is then transmitted to client 120 at step 214 where a determination is made to grant or deny access to the desired content. In one example, all content that is to be made available to be purchased and downloaded is pre-encoded and stored in content database 114. In one embodiment, the retrieved device identifiers, which are received in encrypted form from the client, can be bound to the pre-encrypted content in step 212 in a way that could facilitate processing time. For example, the encryption key that is used to encrypt the device identifier table can also be used to encrypt the key that was used to pre-encrypt the content. In this manner, access to the device identifier table and the content can be obtained using a single encryption key. In another example, security is improved by using two different encryption keys to encrypt the device identifier table and the content. In an alternate embodiment, content is stored in unencrypted form. Here, the content and the device identifier table would both be encrypted when the content is requested by client 120.

As would be appreciated, the specific method by which the protected content file is created would be implementation dependent. An example of such a process for creating a protected content file is provided in nonprovisional patent application Ser. No. 10/899,081, entitled “System and Method for Enabling Device Dependent Rights Protection,” filed Jul. 27, 2004, which is incorporated herein by reference in its entirety. In one embodiment, the protected content file is created in a media exchange format (MXF) technology.

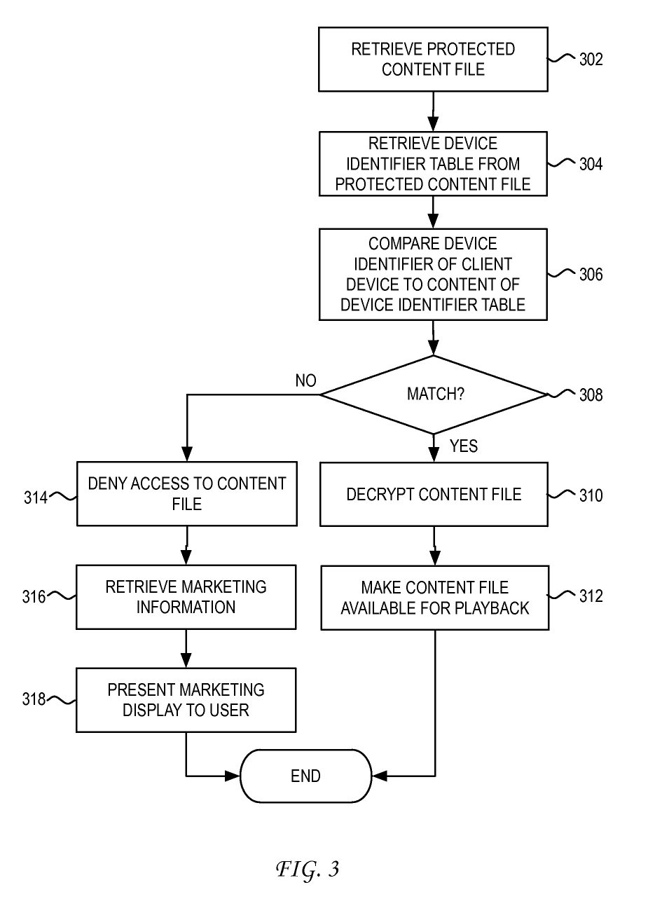

FIG. 3 is a flowchart illustrating the process where the protected content received from content provider 110 is accessed by client 120. This process begins at step 302 where the protected content file is retrieved. At step 304, the device identifier table is extracted from the protected content file. In one embodiment, only the device identifier portion of the protected content file is decrypted initially. Next, at step 306, the unique client identifier of the client device on which the content is to be played is compared to the list of unique client identifiers included in the extracted device identifier table. In one embodiment, the same function used to retrieve the unique device identifiers at step 204 of FIG. 2 is used to retrieve the unique device identifier of the current device.

At step 308, a determination is then made as to whether the device identifier of the client device on which the content is to be played is included amongst the set of one or more device identifiers included in the device identifier table. If it is determined at step 308 that the client device identifier is included in the device identifier table, then the client device represents an authorized device. The process would then continue to step 310 where the downloaded encrypted content is decrypted. Next, at step 312, the content is made available for playback on the client device.

If, on the other hand, it is determined at step 308 that the client device identifier is not included in the device identifier table, then a match does not result. At step 314, the user is then denied access to the content file at step 314. As part of this process, an alert can be presented to the user indicating that he does not have proper rights to access the content. This situation can occur, for example, if the user received a copy of the protected content file from an individual that originally purchased playback rights. As the user's device identifier was not provided to the server at the time the protected content file was created, the user's device identifier would not be included in the device identifier table.

It is a feature of the present invention that this unauthorized distribution scenario can still be leveraged as part of a marketing/promotional framework. Instead of having the denial of access at step 314 be the end of the process, marketing information (e.g., URL) can be retrieved from the protected content file at step 316. This retrieved marketing information can then be used to generate a marketing display to the user at step 318. For example, a retrieved URL can be used at step 318 to direct the user's web browser to the URL address. In one example, this URL address is for a web page that enables the user to purchase playback rights to the content. In another example, the URL address is for a web page that enables the user to view a promotional video of the content (e.g., movie trailer).

In general, the denial of access to the content file at step 314 represents an opportunity to present marketing/promotional information to the user. In various examples, the user can also be directed to web sites that contain concert information, discount coupons (e.g., for albums, movies, concert tickets, etc.), promotional information, or the like. It should be noted that in an alternative embodiment, the protected content file can also be designed to include the marketing/promotional information directly instead of the URL. In this scenario, the user would be presented with marketing/promotional information that has been retrieved from the protected content file itself. It should also be noted that marketing/promotional information can also be presented to the user when the user is authorized to access the protected content. In this scenario, the marketing/promotional information could be used to offer the user additional purchasing opportunities or simply present additional information that is related to the content.

As has been described, the inclusion of marketing/promotional information directly or indirectly (e.g., via a URL) in a protected content file enables the content provider to leverage a digital content distribution framework. This distribution framework is inherently targeted as a user's attempted access is in itself an indication of a level of interest in the content. This interest represents a natural opportunity to apply additional marketing/promotional tools to increase aggregate sales in content-related areas.

Although the above description may contain specific details, they should not be construed as limiting the claims in any way. Other configurations of the described embodiments of the invention are part of the scope of this invention. Accordingly, the appended claims and their legal equivalents only should define the invention, rather than any specific examples given.

What is claimed is:

1. A content protection method, comprising:
receiving a protected content file in a client device, said protected content file including a device identifier table that contains one or more client device identifiers;
retrieving an identifier for said client device in which said protected content file resides;
upon receipt of a command to access said protected content file, comparing said retrieved identifier to said client device identifiers in said device identifier table; and
if said device identifier does not match one of said client device identifiers in said device identifier table, then restricting access to protected content in said protected content file and directing a web browser program on said client device to a uniform resource locator address that is retrieved from said protected content file.

2. The method of claim 1, wherein said receiving comprises receiving a protected content file that includes an audio file.

3. The method of claim 1, wherein said receiving comprises receiving a protected content file that includes a video file.

4. The method of claim 1, wherein said receiving comprises receiving a protected content file that includes an encrypted portion and an unencrypted portion, wherein said unencrypted portion includes said uniform resource locator address.

5. The method of claim 1, wherein said directing comprises directing said web browser program to a purchasing site for said protected content

6. The method of claim 1, wherein said directing comprises directing said web browser program to an information site for said protected content.

7. The method of claim 1, wherein said retrieving comprises retrieving a product identification number.

8. The method of claim 1, wherein said retrieving comprises retrieving a serial number.

9. The method of claim 1, wherein said retrieving comprises retrieving a product revision number.

10. A system for protecting content from unauthorized access, comprising:
means for receiving a protected content file in a client device, said protected content file including a device identifier table that contains one or more client device identifiers;
means for retrieving an identifier for said client device in which said protected content file resides;
means for comparing said retrieved identifier to said client device identifiers in said device identifier table upon receipt of a command to access said protected content file; and
means for restricting access to protected content in said protected content file if said means for comparing does not indicate a match; and
means for directing a web browser program on said client device to a uniform resource locator address that is retrieved from said protected content file.

11. The system of claim 10, wherein said protected content file includes an audio file.

12. The system of claim 10, wherein said protected content file includes a video file.

13. The system of claim 10, wherein said protected content file includes an encrypted portion and an unencrypted portion, wherein said unencrypted portion includes said uniform resource locator address.

14. The system of claim 10, wherein said uniform resource locator address is for a purchasing site for said protected content.

15. The system of claim 10, wherein said uniform resource locator address is for an information site for said protected content.

16. A content protection method, comprising:
receiving one or more unique identifiers that correspond to one or more client devices;
creating a protected content file that includes a content file, a device identifier table containing said one or more unique identifiers of said plurality of client devices, and a uniform resource locator address; and
sending said protected content file to a user, access to said content file being based on a comparison of an identifier associated with a client device used for said access with said one or more unique identifiers in said device identifier table, wherein a web browser on said client device is directed to said uniform resource locator address upon a failure in said comparison.

17. The method of claim 16, wherein said creating comprises including said uniform resource locator address in an unencrypted portion of said protected content file.

18. The method of claim 17, wherein said uniform resource locator address is to one of a purchaser site and an information site.

19. The method of claim 16, wherein said creating comprises creating a protected content file that includes an audio file

20. The method of claim 16, wherein said creating comprises creating a protected content file that includes a video file.
